(19) United States
(12) Patent Application Publication
(10) Pub. No.: US 2026/0075652 A1
(43) Pub. Date: Mar. 12, 2026

(54) SYNCHRONIZING WIRELESS COMMUNICATIONS BETWEEN USER EQUIPMENT AND NON-TERRESTRIAL NETWORKS

(71) Applicant: Apple Inc., Cupertino, CA (US)

(72) Inventors: Pranav Tripathi, San Jose, CA (US); Anjaneyulu Maganti, San Jose, CA (US); Dhruv Khati, San Jose, CA (US); Krishna Myneni, San Jose, CA (US); Sanjeevi Balasubramanian, San Jose, CA (US)

(21) Appl. No.: 18/882,208

(22) Filed: Sep. 11, 2024

(51) Int. Cl. H04W 74/0833; H04B 7/185

(52) U.S. Cl. CPC H04W 74/0833; H04B 7/18519

(57) ABSTRACT

Disclosed are methods, systems, and computer-readable medium to perform operations including: determining a trajectory and an elevation angle of a first communications satellite of a non-terrestrial network relative to a user equipment (UE); determining, based on the trajectory and the elevation angle of the first communication satellite, whether one or more first criteria have been satisfied; and performing at least one of: (i) upon determining that the one or more first criteria have been satisfied, causing the UE to perform a 2-Step Random Access Channel (RACH) procedure with respect to the first communications satellite and the non-terrestrial network, or (ii) upon determining that the one or more first criteria have not been satisfied, causing the UE to perform a 4-Step RACH procedure with respect to the first communications satellite and the non-terrestrial network.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

In general, wireless user devices (e.g., user equipment, UE) can communicate with a non-terrestrial network via one or more orbiting satellites. As an example, a UE can transmit uplink data to a satellite, and the satellite can relay at least a portion of the data to components of a network (e.g., a terrestrial base station, another satellite, etc.). As another example, a satellite can receive downlink data from a component of the network (e.g., a terrestrial base station, another satellite, etc.), and relay at least a portion of the data to the UE.

In some implementations, a UE can establish a connection with the network by performing a Random Access Channel (RACH) synchronization procedure. As an example, a UE can perform a 2-Step RACH procedure or a 4-Step RACH procedure, whereby the UE and the network exchanges messages (e.g., two messages or four messages, respectively) via a satellite in order to synchronize communications between them and to exchange data with one another.

Further, in some implementations, the UE can selectively perform a 2-Step RACH procedure or a 4-Step RACH procedure, depending on the location of the satellite relative to the UE and/or the trajectory of the satellite. For instance, in at least some implementations, it is more efficient to perform a 2-Step RACH procedure than a 4-Step RACH procedure, due to the lower signaling overhead of the 2-Step RACH procedure. Further, 2-Step RACH may have lower latency compared to 4-Step RACH. However, in at least some implementations, the 4-Step RACH procedure may be more resilient than the 2-Step RACH procedure to connectivity or network coverage issues. To balance these factors, a UE can selectively perform the 2-Step RACH procedure via a satellite when the link quality between the UE and the satellite is predicted to be sufficiently high (e.g., based on the location of the satellite relative to the UE and/or the trajectory of the satellite). Alternatively, the UE can “fallback” to performing the 4-Step RACH procedure via the satellite if the predicted link quality is not sufficiently high and/or if the 2-Step RACH procedure was unsuccessful.

The techniques described herein provide specific technical benefits in the context of non-terrestrial networks. For example, the techniques herein allow UEs to selectively connect to non-terrestrial networks (e.g., via satellites) using either a 2-Step RACH or a 4-Step RACH procedure, depending on the context of use. This dynamic selection technique improves the performance and efficiency of communications between the UE and the network (e.g., by enabling the UE and network to exchange fewer messages via the 2-Step RACH in at least some circumstances, which can reduce utilization of the network and/or reduce load on the UE). In some implementation, this can also lower the power consumption by the UE. Further, this dynamic selection technique also maintains reliable communications between the UE and the network (e.g., by enabling fallback to the 4-Step RACH, depending on the context of use).

In accordance with one aspect of the present disclosure, a method includes: determining a trajectory and an elevation angle of a first communications satellite of a non-terrestrial network relative to a user equipment (UE); determining, based on the trajectory and the elevation angle of the first communication satellite, whether one or more first criteria have been satisfied; and performing at least one of: (i) upon determining that the one or more first criteria have been satisfied, causing the UE to perform a 2-Step Random Access Channel (RACH) procedure with respect to the first communications satellite and the non-terrestrial network, or (ii) upon determining that the one or more first criteria have not been satisfied, causing the UE to perform a 4-Step RACH procedure with respect to the first communications satellite and the non-terrestrial network.

Implementations of this aspect can include one or more of the following features.

In some implementations, determining that the one or more first criteria have been satisfied can include determining that the non-terrestrial network supports 2-Step RACH.

In some implementations, determining that the one or more first criteria have been satisfied can include determining that the elevation angle of the first communication satellite is greater than a threshold angle.

In some implementations, the threshold angle can be variable, and the threshold angle can be determined based on a location of the UE.

In some implementations, determining that the one or more first criteria have been satisfied can include determining, based on the trajectory of the first communication satellite, that the elevation angle of the first communication satellite will be greater than the threshold angle for at least a threshold period of time.

In some implementations, determining that the one or more first criteria have not been satisfied can include at least one of: (i) determining that the non-terrestrial network does not support 2-Step RACH, (ii) determining that the elevation angle of the first communication satellite is not greater than a threshold angle, (iii) determining, based on the trajectory of the first communication satellite, that the elevation angle of the first communication satellite will not be greater than the threshold angle for at least a threshold period of time, or (iv) determining that the 2 Step RACH procedure was unsuccessful.

In some implementations, the method can include (i) subsequent to causing the UE to perform the 4-Step RACH procedure with respect to the first communications satellite and the non-terrestrial network, determining that the 4-Step RACH procedure was unsuccessful, (ii) in response to determining that the 4-Step RACH procedure was unsuccessful, determining that the elevation angle of the first communication satellite is greater than the threshold angle at a future time, and (iii) determining whether to cause the UE to perform the 2-Step RACH procedure or the 4-Step RACH procedure with respect to the first communications satellite and the non-terrestrial network at the future time.

In some implementations, performing the 2-Step RACH procedure can include: (i) preparing a first message for transmission to the non-terrestrial network via the first communications satellite, the first message including: a Physical Random Access Channel (PRACH) preamble, and a Physical Uplink Shared Channel (PUSCH payload), and (ii) receiving a second message from the non-terrestrial network via the first communications satellite in response to the first message, the second message including a Random Access Response (RAR).

In some implementations, performing the 4-Step RACH procedure can include: (i) preparing a first message for transmission to the non-terrestrial network via the first communications satellite, the first message including a Physical Random Access Channel (PRACH) preamble, (ii) receiving a second message from the non-terrestrial network via the first communications satellite in response to the first message, the second message including a Random Access Response (RAR), (iii) preparing a third message for transmission to the non-terrestrial network via the first communications satellite, the third message including a Physical Uplink Shared Channel (PUSCH) payload, and (iv) receiving a fourth message from the non-terrestrial network via the first communications satellite in response to the third message, the fourth message confirming receipt of the PUSCH payload by the non-terrestrial network.

In some implementations, the method can include, subsequent to establishing a connection with the non-terrestrial network via at least one of the 2-Step RACH procedure or the 4-RACH procedure: (i) determining, based on the trajectory of the first communication satellite, whether to transmit data to the non-terrestrial network via the first communications satellite using Receive (Rx) Diversity; and (ii) performing at least one of: preparing data for transmission to the non-terrestrial network via the first the communications satellite without Rx Diversity, or causing the data to be transmitted the non-terrestrial network via the first the communications satellite with Rx Diversity.

In some implementations, the method can include, subsequent to establishing a connection with the non-terrestrial network via at least one of the 2-Step RACH procedure or the 4-RACH procedure: (i) determining a trajectory and an elevation angle of a second communications satellite of the non-terrestrial network relative to the UE; (ii) determining a priority of data to be transmitted to the non-terrestrial network; (iii) determining a size of the data; (iv) determining whether to transmit the data to non-terrestrial network via the first communications satellite or the second communications satellite based on: the trajectory and the elevation angle of the first communications satellite, the trajectory and the elevation angle of the second communications satellite, and the priority of the data, and the size of the data; and (iv) performing at least one of: causing the data to be transmitted the non-terrestrial network via the first communications satellite, or causing the data to be transmitted the non-terrestrial network via the second communications satellite.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 illustrates an example system including a user equipment (UE) a satellite, and a base station.

FIG. 3 illustrates an example process for selecting between a 2-Step Random Access Channel (RACH) procedure and a 4-Step RACH procedure.

FIG. 4A illustrates an elevation angle of a satellite relative to a UE.

FIG. 4B illustrates an example trajectory of a satellite relative to a UE and the corresponding receive power of signals transmitted from the satellite to the UE.

FIG. 5 illustrates trajectories of several satellites relative to a UE.

FIG. 6 illustrates a flowchart of an example method.

FIG. 7 illustrates an example UE.

FIG. 8 illustrates an example access node.

### DETAILED DESCRIPTION

In general, user equipment (UE) can communicate with a non-terrestrial network via one or more orbiting satellites (e.g., satellites orbiting in low Earth orbit, LEO). In particular, the UE can establish a connection with the network by performing a Random Access Channel (RACH) synchronization procedure. As an example, a UE can perform a 2-Step RACH procedure or a 4-Step RACH procedure, whereby the UE and the network exchanges messages (e.g., two messages or four messages, respectively) via a satellite in order to synchronize communications between them and to exchange data with one another.

Further, the UE can selectively perform a 2-Step RACH procedure or a 4-Step RACH procedure, depending on the location of the satellite relative to the UE and/or the trajectory of the satellite. This dynamic selection technique improves the performance and efficiency of communications between the UE and the network (e.g., by enabling the UE and network to exchange fewer messages via the 2-Step RACH in at least some circumstances, which can reduce utilization of the network, reduce load on the UE, and/or lower latency). In some implementation, this can also lower the power consumption by the UE. Further, this dynamic selection technique also maintains reliable communications between the UE and the network (e.g., by enabling fallback to the 4-Step RACH, depending on the context of use).

Example implementations of the dynamic selection technique are described in further detail herein.

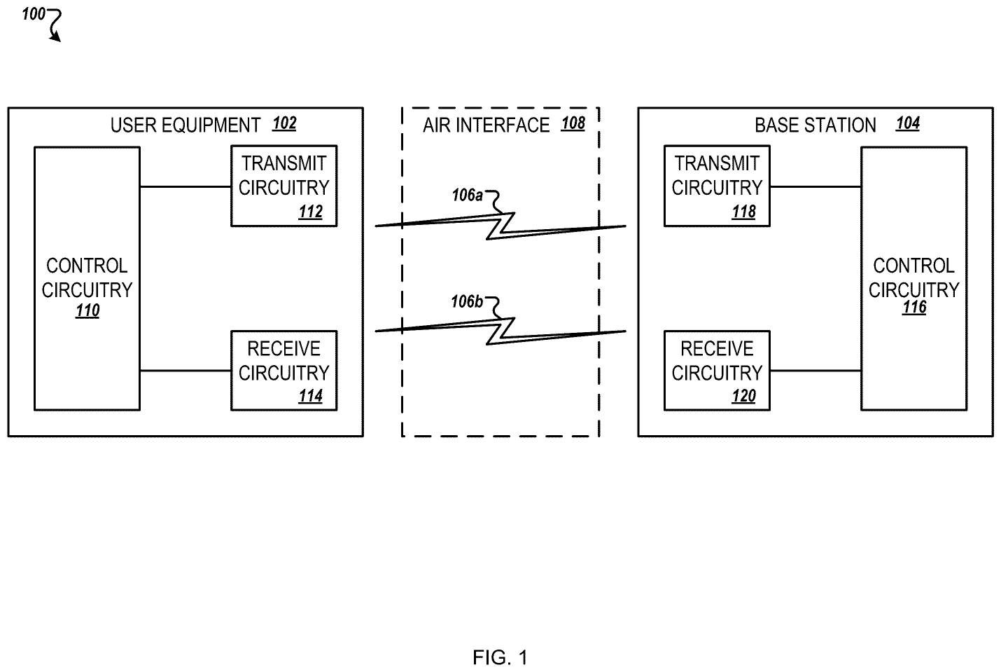

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can be adapted or configured to cause the UE 102 to establish a connection with the base station 104. For example, the control circuitry 110 can be adapted or configured to selectively cause the UE 102 to establish a connection via a 2-Step RACH procedure or a 4-Step RACH procedure, depending on the context (e.g., as discussed further detail below).

The transmit circuitry 112 can perform various operations described in this specification. For example, the transmit circuitry 112 can transmit data (e.g., in the form of wireless signals) to the base station 104. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 1108.

The receive circuitry 114 can perform various operations described in this specification. For instance, the receive circuitry 114 can receive data (e.g., in the form of wireless signals) from the base station 104. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell (e.g., a satellite), or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer. In some implementation, the base station 104 may be a 5G radio access network (RAN),

For instance, in at least some implementations, the base station 104 can include a satellite of a non-terrestrial network (NTN) that is orbiting the Earth or other celestial object (e.g., planet, moon, asteroid, star, etc.). As an example, the base station 104 can relay data (e.g., in the form of wireless signal) between the UE 102 and other portion of the non-terrestrial network (e.g., other satellites, terrestrial base stations, etc.).

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

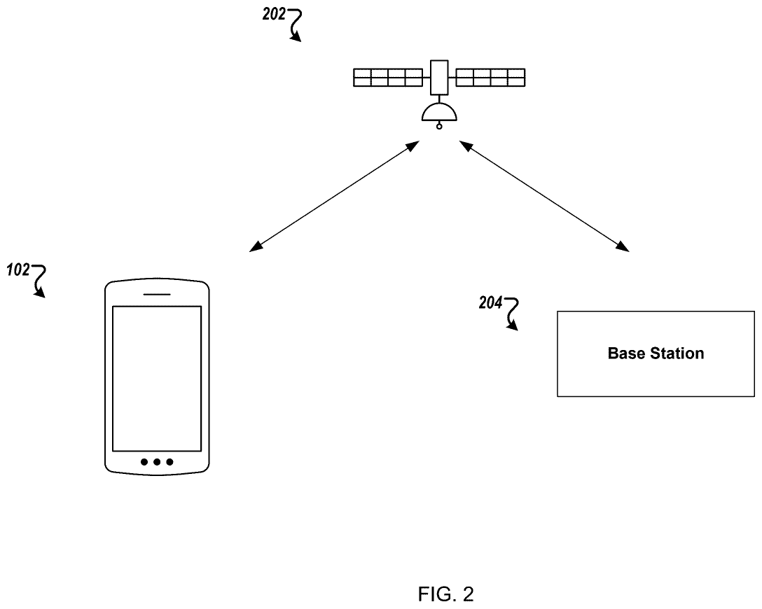

FIG. 2 shows an example system 200 including a UE 102, a satellite 202 (e.g., a satellite orbiting above the Earth), and a base station 204. In general, the satellite 202 and the base station 204 can be similar to the base station 104 described with reference to FIG. 1.

The UE 102 can communicate with a non-terrestrial network via the satellite 202 and the base station 204. For example, as shown in FIG. 2, the UE can establish a connection with the satellite 202 and transmit data (e.g., in the form of wireless signals) to the satellite 202. The satellite 202 can relay at least a portion of the data to a base station 204. In turn, the base station 204 can provide at least a portion of the data to one or more additional components of the network (e.g., one or more additional devices that are communicatively coupled to the base station 204 by wireless and/or wired communications links, such as other UEs, server computers, etc.).

As another example, referring to FIG. 2, the base station 204 can receive data from one or more additional components of the network (e.g., one or more additional devices that are communicatively coupled to the base station 204), and transmit at least a portion of the data (e.g., in the form of wireless signals) to the satellite 202. The satellite 202 can relay at least a portion of the data to the UE 102.

In some implementations, the UE 102 can be deployed on the ground (e.g., such as on the surface of the Earth). In some implementations, the base station 204 can be a terrestrial base station (e.g., a base station that is also deployed on the ground). In some implementations, the base station 204 can be a non-terrestrial base station (e.g., an additional satellite that orbits the Earth).

In general, the UE 102 can establish a connection with the network by performing a Random Access Channel (RACH) synchronization procedure. As an example, a UE can perform a 2-Step RACH procedure or a 4-Step RACH procedure, whereby the UE and the network exchanges messages (e.g., two messages or four messages, respectively) via a satellite in order to synchronize communications between them and to exchange data with one another.

As an example, according to the 2-Step RACH procedure, the UE 102 transmits a first message to the network (e.g., via the satellite 202 and/or the base station 204). The first message may be referred to as “Message A” or “MsgA.” The first message includes a Physical Random Access Channel (PRACH) preamble and a Physical Uplink Shared Channel (PUSCH payload). In general, the PRACH preamble is used to request access to the network, whereas the PUSCH carries additional data used by the network to process the request.

In response to the first message, the network transmits a second message to the UE 102 (e.g., via the satellite 202 and/or the base station 204). The second message may be referred to as “Message B” or “MsgB.” The second message includes a Random Access Response (RAR) message and a Contention Resolution message. The RAR message includes information such as timing advance, uplink grant, and temporary C-RNTI (Cell Radio Network Temporary Identifier). The Contention Resolution message includes information that facilities the granting of network access to the UE, including information that enables the UE to resolve any potential conflicts (e.g., if multiple UEs had sent the same preamble to the network).

As another example, according to the 4-Step RACH procedure, the UE 102 transmits a first message to the network (e.g., via the satellite 202 and/or the base station 204). The first message may be referred to as “Message 1” or “Msg1.” The first message includes a Physical Random Access Channel (PRACH) preamble, which is a specific sequence used to request access and synchronize with the network. For example, the PRACH preamble includes identifying information that allows the network to identify the UE 102 and determine the timing advance needed for synchronization.

In response to the first message, the network transmits a second message to the UE 102 (e.g., via the satellite 202 and/or the base station 204). The second message may be referred to as “Message 2” or “Msg2.” The second message includes a Random Access Response (RAR) message, as described above.

In response to the second message, the UE 102 transmit a third message to the network (e.g., via the satellite 202 and/or the base station 204). The third message may be referred to as “Message 3” or “Msg3.” The third message includes a Radio Resource Control (RRC) Connection Request, which includes the UE's identity and the reason for the access request. The third message is transmitted on the Physical Uplink Shared Channel (PUSCH) using the resources allocated in the second message.

In response to the third message, the network transmits a fourth message to the UE 102 (e.g., via the satellite 202 and/or the base station 204). The fourth message includes a Contention Resolution message, which confirms the successful reception of the third message and resolves any contention (e.g., if multiple UEs sent the same preamble to the network), as described above.

In some implementations, the UE 102 selectively performs the 2-Step RACH procedure or the 4-Step RACH procedure, depending on the location of satellite 202 relative to the UE 102 and/or the trajectory of the satellite 202. This dynamic selection technique improves the perform and efficiency of communications between the UE 102 and the network (e.g., by enabling the UE 102 and network to exchange fewer messages via the 2-Step RACH in at least some circumstances, which can reduce utilization of the network, reduce load on the UE 102, and/or lower latency). In some implementation, this can also lower the power consumption by the UE. Further, this dynamic selection technique also maintains reliable communications between the UE 102 and the network (e.g., by enabling fallback to the 4-Step RACH, depending on the context of use).

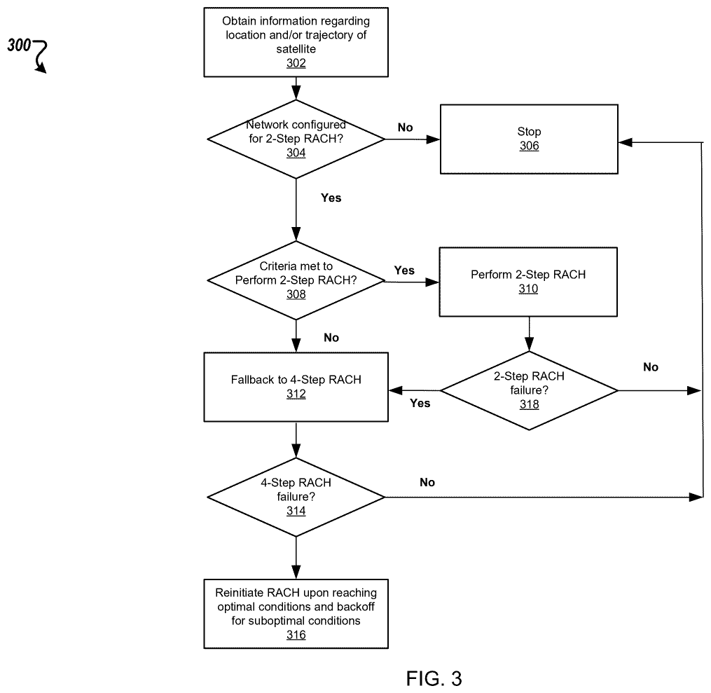

An example process 300 for selecting between the 2-Step RACH procedure and the 4-Step RACH procedure is shown in FIG. 3. The process 300 can be performed, for example, by the UE 102.

According to the process 300, the UE 102 obtains information regarding the location of the satellite 202 relative to the UE 102 and/or the trajectory the satellite 202 (e.g., the location of the satellite 202 over a period of time) (block 302).

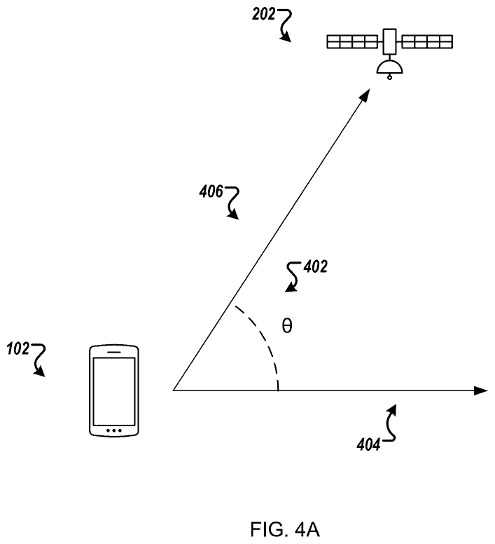

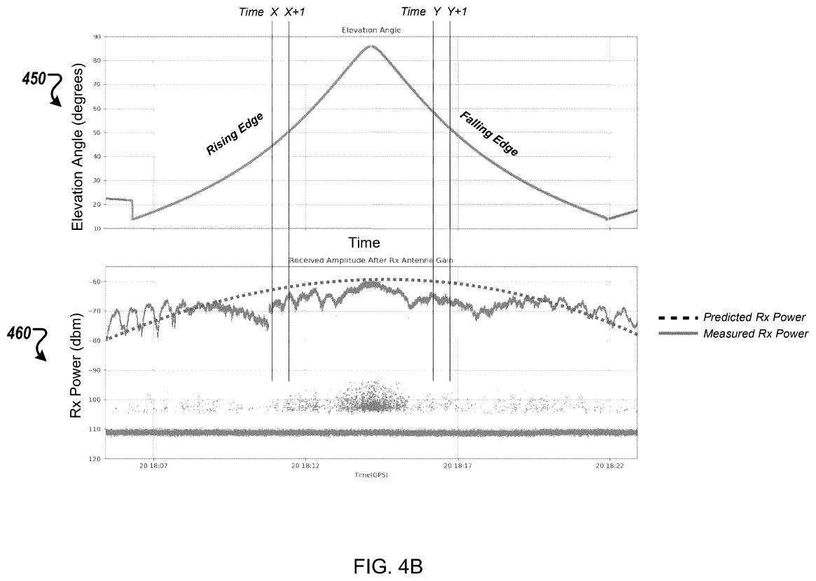

In some implementations, this information can include the elevation angle of the satellite 202 relative to the UE 102. For example, referring to FIG. 4A, the elevation angle 402 of the satellite 202 relative to the UE 102 can refer to the angle θ between a horizontal axis 404 (e.g., on Earth, a direction along a plane this is orthogonal to the direction of gravity at the location of the UE 102) and a line 406 extending between the location of the UE 102 and the satellite 202. Further, the trajectory of the satellite 202 can be represented as the satellite's elevation angle 402 relative to the UE 102 over a period of time (e.g., as shown in plot 450 of FIG. 4B).

Referring back to FIG. 3, the UE 102 determines whether the network is configured to establish connections via the 2-Step RACH procedure (block 304). In some implementations, the UE 102 can make this determination based on pre-determined information (e.g., pre-existing information regarding the network and/or pre-existing configurations with respect to the network) and/or based on signaling by the network.

If the UE 102 determines the network is not configured to establish connections via the 2-Step RACH procedure, the UE 102 stops the process 300 (block 306). In some implementations, in response, UE 102 can by default perform the 4-Step RACH procedure instead (e.g., as a fallback to the 2-Step RACH procedure).

If the UE 102 determines the network is configured to establish connections via the 2-Step RACH procedure, the UE 102 determines whether a set of criteria for performing the 2-Step RACH procedure have been met (block 308).

In some implementations, the set of criteria can include a first criterion that the elevation angle of the satellite be greater than (or greater than or equal to) a particular threshold angle. For example, referring to plot 450 of FIG. 4A, this can refer to a period of time between Time X+1 and Time Y+1 during which the elevation angle of the satellite 202 is greater than a threshold angle (in this example, 50 degrees). As shown in plot 460 of FIG. 4B, this can correspond to a period of time during which the receive power (Rx Power) of signals transmitted from the satellite 202 to the UE 102 is predicted to be the highest (e.g., corresponding to when the satellite 202 is directly overhead the UE 102, including a “leading edge” period of time leading up to the peak and a “falling edge” period of time away from the peak), which makes it more likely than the 2-Step RACH procedure can be performed successfully.

In the example shown in FIG. 4B, the threshold angle is 50 degrees. This angle may be particularly suitable for satellite in certain trajectories in LEO. However, in practice, the threshold angle can differ depending the trajectory of each satellite and/or of a satellite constellation. For example, in some implementations, the threshold angle can be between 15 degrees to 20 degrees.

In some implementations, the threshold angle can be dynamically selected based on the context of use. For example, when the UE 102 is in an area that is likely to have obstructions to the line of sight to a satellite (e.g., an urban area with tall structures, area with mountains or hills, areas with tall trees, etc.), the UE 102 can select a relatively greater angle. Accordingly, the UE 102 would perform the 2-Step RACH procedure when the satellite is nearer to overhead point, and is less like to be obstructed. As another example, when the UE 102 is in an area that is less likely to have obstructions to the line of sight to a satellite (e.g., a flat area with few obstructions), the UE 102 can select a relatively smaller angle. Accordingly, the UE 102 would selectively performs the 2-Step RACH procedure for a wider range of elevation angles, compared to in an obstructed area. In some implementations, the threshold angle can be selected based on the location of the UE 102. For example, the UE 102 can obtain or access a database linking or mapping geographical locations or regions to corresponding threshold angles. Based on its location (e.g., as determined by a location sensor, such as a GPS sensor), the UE 102 can determine the threshold angle for that location, and use that threshold angle to determine whether to the perform 2-Step RACH procedure or the 4-Step RACH procedure.

Further, the set of criteria can include a second criterion that the elevation angle of the satellite is predicted to remain greater than (or remain greater than or equal to) the threshold angle for a threshold period of time T_{threshold}. In some implementations, this prediction can be made based on the trajectory of the satellite 202 obtained in step 302 (e.g., information regarding the current and future trajectory of the satellite 202). In some implementations, the threshold period of time T_{threshold} can be 30 seconds. However, in practice, the threshold period of time can differ, depending on the implementation.

If the UE 102 determines that the set of criteria for performing the 2-Step RACH procedure are met, (e.g., the elevation angle is greater than the threshold angle and is predicted to remain so for longer than the threshold period of time), the UE 102 performs the 2-Step RACH procedure (block 310), as described above.

However, if the UE 102 determines that the set of criteria for performing the 2-Step RACH procedure are not met, (e.g., the elevation angle is less than the threshold angle and/or the elevation angle is predicted not to remain greater than the threshold angle for longer than the threshold period of time), the UE 102 falls back to performing the 4-Step RACH procedure (block 312), as described above.

Further, the UE 102 continues monitoring (e.g., continuously, periodically, intermittently, etc.) whether the optimal set of conditions for performing the 2-Step RACH procedure are present (block 314). Upon determining that the set of criteria for performing the 2-Step RACH procedure are later met (e.g., the elevation angle of the satellite 202 later becomes greater than a threshold angle and is predicted to remain so for greater than the threshold period of time), the UE 102 reinitiates the 2-Step RACH procedure (e.g., block 310). Otherwise, the UE 102 backs off of the 2-Step RACH process (e.g., by refraining from performing the 2-Step RACH procedure during while the set of criteria are not met).

If the 4-Step RACH procedure is unsuccessful (e.g., the UE 102 does not receive Message 2 and/or Message 4 from the network, or receives corrupted versions of those messages), the UE the UE 102 continues monitoring (e.g., continuously, periodically, intermittently, etc.) whether the optimal set of conditions for performing the 2-Step RACH procedure are present (blocks 314, 316). Upon determining that the set of criteria for performing the 2-Step RACH procedure are later met (e.g., the elevation angle of the satellite 202 later becomes greater than a threshold angle and is predicted to remain so for greater than the threshold period of time), the UE 102 reinitiates the 2-Step RACH procedure (e.g., block 310). Otherwise, the UE 102 backs off of the 2-Step RACH process (e.g., by refraining from performing the 2-Step RACH procedure during while the set of criteria are not met).

If the 4-Step RACH procedure is successful (e.g., the UE 102 receives uncorrupted version of Message 2 and/or Message 4 from the network), the UE stops the process 300 (blocks 314, 306).

Referring back to block 310, if the 2-Step RACH procedure is unsuccessful (e.g., the UE 102 does not receive Message B from the network or Message B has been corrupted), the UE 102 falls back to performing the 4-Step RACH procedure (blocks 318, 312). Alternatively, if the 2-Step RACH procedure is successfully performed (e.g., the UE 102 receives an uncorrupted Message B), the UE 102 stops the process 300 (blocks 318, 306)

In some implementations, after the UE 102 has established a connection to the network (e.g., via the satellite 202), the UE 102 can selectively determine whether to receive data from the network using Receive (Rx) Diversity based on the context of use, in order to operate more efficiency.

In general, the UE 102 can be configured to receive data from the network using Rx Diversity, in which antennas of the UE 102 are used to receive the same signal transmitted by the network over different paths. This can be beneficial, for example, in reducing signal fading and interference, which can degrade signal quality. By capturing multiple versions of the signal, the UE 102 can combine them to improve the overall signal quality.

In some implementations, the UE 102 can selectively utilize Rx Diversity based on the expected signal quality from the satellite. For example, under suboptimal conditions (e.g., when the elevation angle of the satellite relative to the UE 102 is less than the threshold angle and the signal quality is expected to be low), the UE 102 can utilize Rx Diversity to the greatest extent possible (e.g., by receiving the signal by the maximum number of times permitted, according to the configuration to the UE 102). This may be referred to receiving a particular maximum number of “Rx chains.”

As another example, under optimal conditions (e.g., when the elevation angle of the satellite relative to the UE 102 is greater than the threshold angle and the signal quality is expected to be high), the UE 102 can reduce the use of Rx Diversity or not use Rx Diversity at all (e.g., by receiving the signal according to reduced number of times, or just a single time).

As another example, between suboptimal and optimal conditions (e.g., when the elevation angle of the satellite relative to the UE 102 is less than the threshold angle, but is approaching the threshold angle along the “rising edge,” and signal quality is expected to be moderate), the UE 102 can receive the signal according to a number of times that is less than that under suboptimal conditions and greater than that under the optimal conditions.

In this way, the UE 102 can balance the benefits of Rx Diversity in improving signal quality, while also selectively reducing the use of Rx Diversity in certain situations to conserve power.

Further, the UE 102 can selectively determine whether to selectively transmit data using the satellite to which it is currently connected, or using another satellite instead (e.g., to improve the speed and/or reliability of communications).

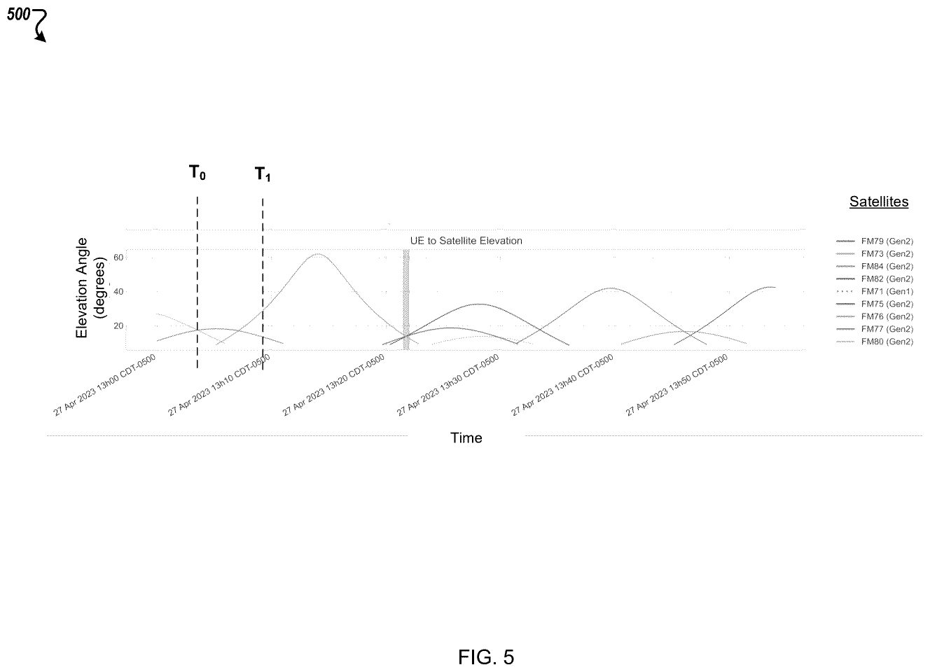

For example, FIG. 5 shows plots 500 of the expected trajectories of several example satellites relative to a UE. In this example, some satellites are expected to have higher elevation angles relative to the UE (and correspondingly, expected to have higher signal quality) compared to other satellites. Further, different satellite are expected to enter into the UE's line of sight at different times. This information can be obtained, for example, as a part of block 302, as described with reference to FIG. 3.

The UE 102 can determine whether to transmit data to a network using the satellite to which it is current connected, or using a different satellite (e.g., a satellite that is expected to enter into the UE's line of sight in the future) based on one or more factors. Example factors include (i) the trajectory and the elevation angle of each of the satellites, (ii) the priority or importance of the data that is to be transmitted, and/or (iii) the size of the data.

For example, referring to FIG. 5, at time T₀ the UE is connected to a satellite that is expected to have a peak elevation angle of less 20 degrees. However, the UE is expected to connected to a second satellite that is expected to have an elevation angle of over 60 degrees in the near future. Based on this determination, the UE can determine whether the data that is be to transmitted to the network has been identified as high priority data (e.g., based on a priority flag, priority tag, etc. associated with the data). If not, the UE can refrain from transmitting the data to the network until it is connected to the second satellite and the elevation angle of the satellite is sufficiently large (e.g., at a time T₁).

As another example, if amount of data to be transmitted is sufficiently large (e.g., such that the time needed to transmit the data is greater than the period of time during which the link quality with a satellite is expected to be high) and the data is not identified as high priority, the UE can refrain from transmitting the data to the network until it is connected to the second satellite.

As another example, the UE can monitor the amount of data that is stored in its buffer and awaiting transmission to the network. If the amount of data in the buffer is greater than a threshold amount, the UE can determine the priority of the data and the trajectory of the satellite(s) to which is it currently connected and any additional satellites that are expected to come into the line of sight of the UE. If (i) the UE is currently connected to a satellite that has an elevation angle of less than a threshold angle and (ii) the data that is to be transmitted is not high priority data, the UE can identify a new period of time within a forward looking window in which the UE is expected to be connected to a satellite that has an elevation angle of greater than the threshold angle. Further, the UE can transmit a Buffer Status Report (BSR) to the network indicating the amount of buffered data for transmission, and the new period of time for transmitting that data. In response, the network can transmit an uplink grant to the UE to transmit the data at the scheduled time (e.g., via a satellite and/or base station). Upon receiving the uplink grant, the UE can transmit the data at the scheduled time.

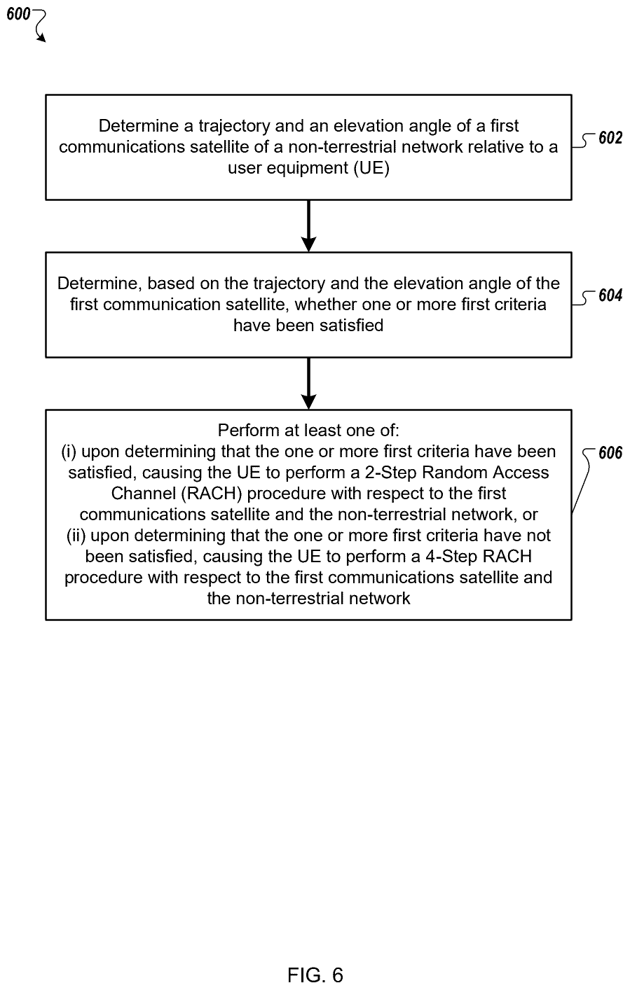

FIG. 6 illustrates a flowchart of an example method 600, according to some implementations. For clarity of presentation, the description that follows generally describes method 600 in the context of the other figures in this description. For example, method 600 can be performed by the UE 102 of FIGS. 1, 2 and 4A. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

According to the method 600, a device (e.g., a UE) determines a trajectory and an elevation angle of a first communications satellite of a non-terrestrial network relative to a user equipment (UE) (602).

Further, the device determines, based on the trajectory and the elevation angle of the first communication satellite, whether one or more first criteria have been satisfied (604).

Further, the device performs at least one of: (i) upon determining that the one or more first criteria have been satisfied, causing the UE to perform a 2-Step Random Access Channel (RACH) procedure with respect to the first communications satellite and the non-terrestrial network, or (ii) upon determining that the one or more first criteria have not been satisfied, causing the UE to perform a 4-Step RACH procedure with respect to the first communications satellite and the non-terrestrial network (606).

In some implementations, determining that the one or more first criteria have been satisfied can include determining that the non-terrestrial network supports 2-Step RACH.

In some implementations, determining that the one or more first criteria have been satisfied can include determining that the elevation angle of the first communication satellite is greater than a threshold angle.

In some implementations, the threshold angle can be variable, and the threshold angle can be determined based on a location of the UE.

In some implementations, determining that the one or more first criteria have been satisfied can include determining, based on the trajectory of the first communication satellite, that the elevation angle of the first communication satellite will be greater than the threshold angle for at least a threshold period of time.

In some implementations, determining that the one or more first criteria have not been satisfied can include at least one of: (i) determining that the non-terrestrial network does not support 2-Step RACH, (ii) determining that the elevation angle of the first communication satellite is not greater than a threshold angle, (iii) determining, based on the trajectory of the first communication satellite, that the elevation angle of the first communication satellite will not be greater than the threshold angle for at least a threshold period of time, or (iv) determining that the 2 Step RACH procedure was unsuccessful.

In some implementations, the method 600 can include (i) subsequent to causing the UE to perform the 4-Step RACH procedure with respect to the first communications satellite and the non-terrestrial network, determining that the 4-Step RACH procedure was unsuccessful, (ii) in response to determining that the 4-Step RACH procedure was unsuccessful, determining that the elevation angle of the first communication satellite is greater than the threshold angle at a future time, and (iii) determining whether to cause the UE to perform the 2-Step RACH procedure or the 4-Step RACH procedure with respect to the first communications satellite and the non-terrestrial network at the future time.

In some implementations, performing the 2-Step RACH procedure can include: (i) preparing a first message for transmission to the non-terrestrial network via the first communications satellite, the first message including: a Physical Random Access Channel (PRACH) preamble, and a Physical Uplink Shared Channel (PUSCH payload), and (ii) receiving a second message from the non-terrestrial network via the first communications satellite in response to the first message, the second message including a Random Access Response (RAR).

In some implementations, performing the 4-Step RACH procedure can include: (i) preparing a first message for transmission to the non-terrestrial network via the first communications satellite, the first message including a Physical Random Access Channel (PRACH) preamble, (ii) receiving a second message from the non-terrestrial network via the first communications satellite in response to the first message, the second message including a Random Access Response (RAR), (iii) preparing a third message for transmission to the non-terrestrial network via the first communications satellite, the third message including a Physical Uplink Shared Channel (PUSCH) payload, and (iv) receiving a fourth message from the non-terrestrial network via the first communications satellite in response to the third message, the fourth message confirming receipt of the PUSCH payload by the non-terrestrial network.

In some implementations, the method can include, subsequent to establishing a connection with the non-terrestrial network via at least one of the 2-Step RACH procedure or the 4-RACH procedure: (i) determining, based on the trajectory of the first communication satellite, whether to transmit data to the non-terrestrial network via the first communications satellite using Receive (Rx) Diversity; and (ii) performing at least one of: preparing data for transmission to the non-terrestrial network via the first the communications satellite without Rx Diversity, or causing the data to be transmitted the non-terrestrial network via the first the communications satellite with Rx Diversity.

In some implementations, the method can include, subsequent to establishing a connection with the non-terrestrial network via at least one of the 2-Step RACH procedure or the 4-RACH procedure: (i) determining a trajectory and an elevation angle of a second communications satellite of the non-terrestrial network relative to the UE; (ii) determining a priority of data to be transmitted to the non-terrestrial network; (iii) determining a size of the data; (iv) determining whether to transmit the data to non-terrestrial network via the first communications satellite or the second communications satellite based on: the trajectory and the elevation angle of the first communications satellite, the trajectory and the elevation angle of the second communications satellite, and the priority of the data, and the size of the data; and (iv) performing at least one of: causing the data to be transmitted the non-terrestrial network via the first communications satellite, or causing the data to be transmitted the non-terrestrial network via the second communications satellite.

The example method 600 shown in FIG. 6 can be modified or reconfigured to include additional, fewer, or different steps (not shown in FIG. 6), which can be performed in the order shown or in a different order.

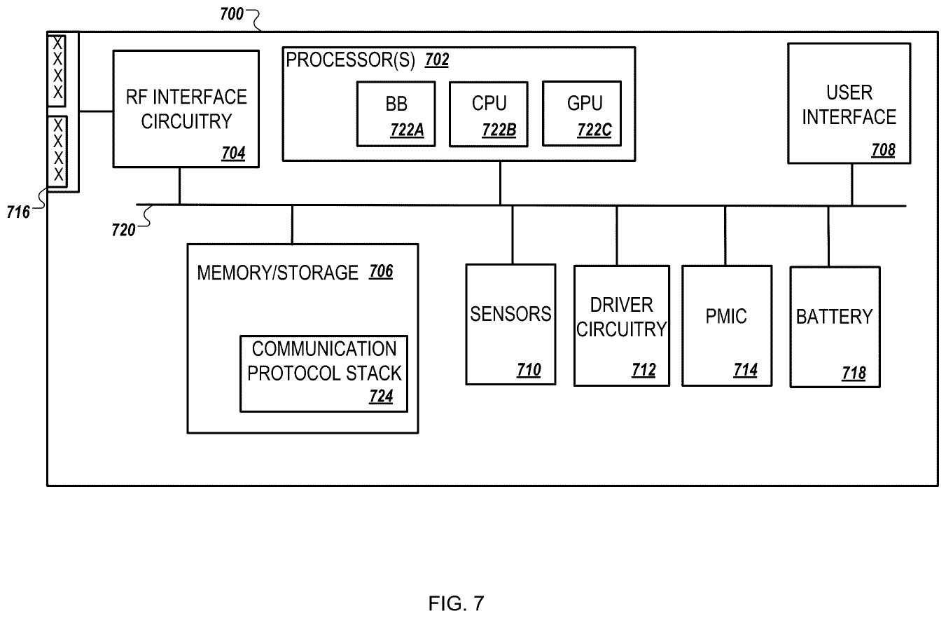

FIG. 7 illustrates an example UE 700. The UE 700 may be similar to and substantially interchangeable with UE 102 of FIG. 1.

The UE 700 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 700 may include any/all of processor 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and a different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc., that allows various circuit components (on common or different chips or chipsets) to interact with one another.

The processor 702 may include one or more processors. For example, the processor 702 may include processor circuitry such as, for example, baseband processor circuitry (BB) 722A, central processor unit circuitry (CPU) 722B, and graphics processor unit circuitry (GPU) 722C. The processor 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by the processor 702 to cause the UE 700 to perform various operations described herein. The memory/storage 706 include any type of volatile or non-volatile memory that may be distributed throughout the UE 700. In some implementations, some of the memory/storage 706 may be located on the processor 702 itself (for example, L1 and L2 cache), while other memory/storage 706 is external to the processor 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 716 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 716. In various implementations, the RF interface circuitry 704 may be configured to transmit/receive signals in a manner compatible with NR access technologies.

The antenna(s) 716 may include one or more antenna elements to convert electrical signals into radio waves to travel through the air and to convert received radio waves over the air into electrical signals. In some implementations, the antenna elements may be arranged into one or more antenna panels. The antenna(s) 716 may have antenna panels that are omnidirectional, directional, or a combination thereof, to enable beamforming and multiple input, multiple output communications. The antenna(s) 716 may include any/all of microstrip antennas, printed antennas fabricated on the surface of one or more printed circuit boards, patch antennas, phased array antennas, etc. The antenna(s) 716 may have one or more panels designed for one or more specific frequency bands, such as bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processor 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

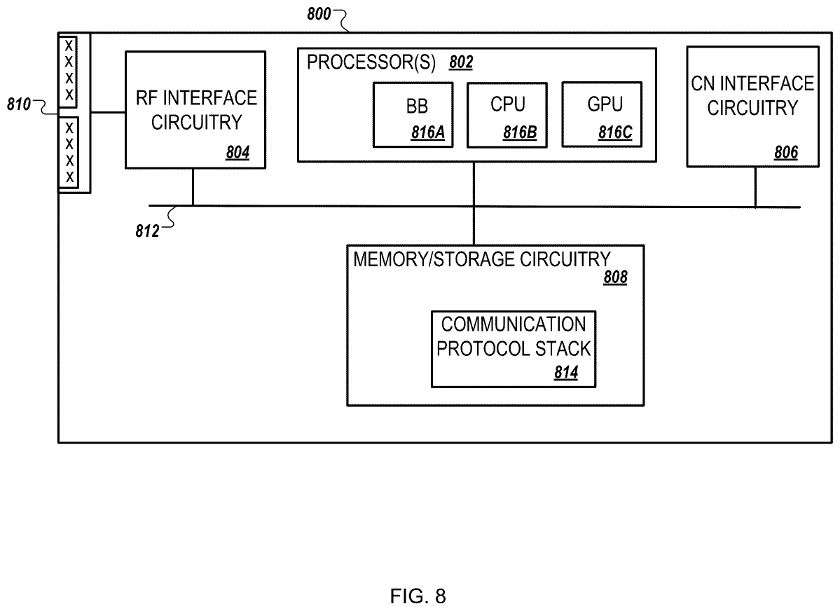

FIG. 8 illustrates an example access node 800 (e.g., a base station or gNB), according to some implementations. The access node 800 may be similar to and substantially interchangeable with base station 104. The access node 800 may include one or more of processor 802, RF interface circuitry 804, core network (CN) interface circuitry 806, memory/storage circuitry 808, and one or more antenna(s) 810. The processor 802 may include any type of circuitry or processor circuitry that executes or otherwise operates computer-executable instructions, such as program code, software modules, or functional processes from memory/storage circuitry 808 to cause the access node 800 to perform operations as described herein.

The components of the access node 800 may be coupled with various other components over one or more interconnects 812. The processor 802, RF interface circuitry 804, memory/storage circuitry 808 (including communication protocol stack 814), antenna(s) 810, and interconnects 812 may be similar to like-named elements shown and described with respect to FIG. 7. For example, the processor 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
determining a trajectory and an elevation angle of a first communications satellite of a non-terrestrial network relative to a user equipment (UE);
determining, based on the trajectory and the elevation angle of the first communication satellite, whether one or more first criteria have been satisfied; and
performing at least one of:
upon determining that the one or more first criteria have been satisfied, causing the UE to perform a 2-Step Random Access Channel (RACH) procedure with respect to the first communications satellite and the non-terrestrial network, or
upon determining that the one or more first criteria have not been satisfied, causing the UE to perform a 4-Step RACH procedure with respect to the first communications satellite and the non-terrestrial network.

2. The method of claim 1, wherein determining that the one or more first criteria have been satisfied comprises:
determining that the non-terrestrial network supports 2-Step RACH.

3. The method of claim 2, wherein determining that the one or more first criteria have been satisfied comprises:
determining that the elevation angle of the first communication satellite is greater than a threshold angle.

4. The method of claim 3, wherein the threshold angle is variable, and wherein the threshold angle is determined based on a location of the UE.

5. The method of claim 3, wherein determining that the one or more first criteria have been satisfied comprises:
determining, based on the trajectory of the first communication satellite, that the elevation angle of the first communication satellite will be greater than the threshold angle for at least a threshold period of time.

6. The method of claim 1, wherein determining that the one or more first criteria have not been satisfied comprises at least one of:
determining that the non-terrestrial network does not support 2-Step RACH,
determining that the elevation angle of the first communication satellite is not greater than a threshold angle,
determining, based on the trajectory of the first communication satellite, that the elevation angle of the first communication satellite will not be greater than the threshold angle for at least a threshold period of time, or
determining that the 2-Step RACH procedure was unsuccessful.

7. The method of claim 1, further comprising:
subsequent to causing the UE to perform the 4-Step RACH procedure with respect to the first communications satellite and the non-terrestrial network, determining that the 4-Step RACH procedure was unsuccessful,
in response to determining that the 4-Step RACH procedure was unsuccessful, determining that the elevation angle of the first communication satellite is greater than the threshold angle at a future time, and
determining whether to cause the UE to perform the 2-Step RACH procedure or the 4-Step RACH procedure with respect to the first communications satellite and the non-terrestrial network at the future time.

8. The method of claim 1, wherein performing the 2-Step RACH procedure comprises:
preparing a first message for transmission to the non-terrestrial network via the first communications satellite, the first message comprising:
a Physical Random Access Channel (PRACH) preamble, and
a Physical Uplink Shared Channel (PUSCH payload), and
receiving a second message from the non-terrestrial network via the first communications satellite in response to the first message, the second message comprising a Random Access Response (RAR).

9. The method of claim 1, wherein performing the 4-Step RACH procedure comprises:
preparing a first message for transmission to the non-terrestrial network via the first communications satellite, the first message comprising a Physical Random Access Channel (PRACH) preamble,
receiving a second message from the non-terrestrial network via the first communications satellite in response to the first message, the second message comprising a Random Access Response (RAR),
preparing a third message for transmission to the non-terrestrial network via the first communications satellite, the third message comprising a Physical Uplink Shared Channel (PUSCH) payload, and
receiving a fourth message from the non-terrestrial network via the first communications satellite in response to the third message, the fourth message confirming receipt of the PUSCH payload by the non-terrestrial network.

10. The method of claim 1, further comprising:
subsequent to establishing a connection with the non-terrestrial network via at least one of the 2-Step RACH procedure or the 4-RACH procedure:
determining, based on the trajectory of the first communication satellite, whether to transmit data to the non-terrestrial network via the first communications satellite using Receive (Rx) Diversity; and
performing at least one of:
preparing data for transmission to the non-terrestrial network via the first the communications satellite without Rx Diversity, or
causing the data to be transmitted the non-terrestrial network via the first the communications satellite with Rx Diversity.

11. The method of claim 1, further comprising:
subsequent to establishing a connection with the non-terrestrial network via at least one of the 2-Step RACH procedure or the 4-RACH procedure:
determining a trajectory and an elevation angle of a second communications satellite of the non-terrestrial network relative to the UE;
determining a priority of data to be transmitted to the non-terrestrial network;
determining a size of the data;
determining whether to transmit the data to non-terrestrial network via the first communications satellite or the second communications satellite based on:
the trajectory and the elevation angle of the first communications satellite,
the trajectory and the elevation angle of the second communications satellite, and
the priority of the data, and
the size of the data; and
performing at least one of:
causing the data to be transmitted the non-terrestrial network via the first communications satellite, or
causing the data to be transmitted the non-terrestrial network via the second communications satellite.

12. (canceled)

13. (canceled)

14. A user equipment (UE) base station comprising one or more processors configured to perform operations comprising:
determining a trajectory and an elevation angle of a first communications satellite of a non-terrestrial network relative to a user equipment (UE);
determining, based on the trajectory and the elevation angle of the first communication satellite, whether one or more first criteria have been satisfied; and
performing at least one of:
upon determining that the one or more first criteria have been satisfied, causing the UE to perform a 2-Step Random Access Channel (RACH) procedure with respect to the first communications satellite and the non-terrestrial network, or
upon determining that the one or more first criteria have not been satisfied, causing the UE to perform a 4-Step RACH procedure with respect to the first communications satellite and the non-terrestrial network.

15. An apparatus comprising one or more baseband processors configured to perform operations comprising:
determining a trajectory and an elevation angle of a first communications satellite of a non-terrestrial network relative to a user equipment (UE);
determining, based on the trajectory and the elevation angle of the first communication satellite, whether one or more first criteria have been satisfied; and
performing at least one of:
upon determining that the one or more first criteria have been satisfied, causing the UE to perform a 2-Step Random Access Channel (RACH) procedure with respect to the first communications satellite and the non-terrestrial network, or
upon determining that the one or more first criteria have not been satisfied, causing the UE to perform a 4-Step RACH procedure with respect to the first communications satellite and the non-terrestrial network.

16. The apparatus of claim 15, wherein determining that the one or more first criteria have been satisfied comprises:
determining that the non-terrestrial network supports 2-Step RACH.

17. The apparatus of claim 15, wherein determining that the one or more first criteria have been satisfied comprises:
determining that the elevation angle of the first communication satellite is greater than a threshold angle.

18. The apparatus of claim 17, wherein the threshold angle is variable, and wherein the threshold angle is determined based on a location of the UE.

19. The apparatus of claim 17, wherein determining that the one or more first criteria have been satisfied comprises:
determining, based on the trajectory of the first communication satellite, that the elevation angle of the first communication satellite will be greater than the threshold angle for at least a threshold period of time.

20. The apparatus of claim 15, wherein determining that the one or more first criteria have not been satisfied comprises at least one of:
determining that the non-terrestrial network does not support 2-Step RACH,
determining that the elevation angle of the first communication satellite is not greater than a threshold angle,
determining, based on the trajectory of the first communication satellite, that the elevation angle of the first communication satellite will not be greater than the threshold angle for at least a threshold period of time, or
determining that the 2-Step RACH procedure was unsuccessful.

21. The apparatus of claim 15, the operations further comprising:
subsequent to causing the UE to perform the 4-Step RACH procedure with respect to the first communications satellite and the non-terrestrial network, determining that the 4-Step RACH procedure was unsuccessful,
in response to determining that the 4-Step RACH procedure was unsuccessful, determining that the elevation angle of the first communication satellite is greater than the threshold angle at a future time, and
determining whether to cause the UE to perform the 2-Step RACH procedure or the 4-Step RACH procedure with respect to the first communications satellite and the non-terrestrial network at the future time.
